(19) United States
(12) Patent Application Publication
(10) Pub. No.: US 2005/0252678 A1
(43) Pub. Date: Nov. 17, 2005

(54) Flexible flat cable

(75) Inventors: Wen-Tung Lee, Taoyuan (TW); Chia-Mien Liu, Taoyuan (TW)

Correspondence Address: TROXELL LAW OFFICE PLLC;Suite 1404, 5205 Leesburg Pike, Falls Church, VA, 22041, US

(73) Assignee: P-Two Industries Inc.

(21) Appl. No.: 10/890,094

(22) Filed: Jul. 14, 2004

(30) Foreign Application Priority Data
May 17, 2004 (TW) 93113803

(51) Int. Cl. H01B 7/08

(52) U.S. Cl. 174/117 F

(57) ABSTRACT

A flexible flat cable contains mainly multiple lines of conductive cable which is elongated to gain better ductility and pressed to change it into a flat cable, encased both on the top and bottom surface with a layer of insulation. The exposed ends of the cable become a section of conductor, on which it is coated with a metal and finally stiffened with reinforcement to become a reliable flexible flat cable. The utmost surface of the conductive ends is further gilt to enhance its conductivity so as to intensify the data transmission efficient when used in LVDS. The purpose of the gilt coating is to harden the cable surface and to restrain the generation of tin tassel from tin coating which would render short circuit in the flat cable.

### BACKGROUND OF THE INVENTION

1. Field of the Invention

This invention relates to the flexible flat cable, in particular the special production method with laminated structure to improve its conductivity, to eliminate the generation of tin tassel which is the victim of short circuit and to ensure the stability.

2. Description of the Related Art

Following the prevalence of the Internet network a variety of communication equipment gains popular among the consumers which makes the data transmission and explosion. Especially in the field of the digitalized video, high resolution TV sets and colorful graphics require broader band to support such data flow. To transmit extremely large amount of data, the system design engineer entirely depends on the analog circuit system technology.

The Low Voltage Differential Signaling (LVDS) is one of the analog technology in which the high speed data transmission is processed in low voltage to gain low energy consumption, low noise, low crosstalk interface, and no electromagnetic interface. The system engineer employs this mixed signaling system to carry out the data transmission in the high speed analog circuit.

The flexible flat cable is indispensable in the LVDS. The prior art of flexible flat cable as shown in FIG. 1, the copper cable 1′ is coated with tin material to prevent the copper from generation of verdigris due to oxidization which is barrier to the current transmission. The cable 1′ is elongated to gain good ductility and pressed in flat form, coated with insulation 2′ and the conductive leads 3′ are stiffened with reinforcement 4′.

The traditional flexible flat cable 1′ is coated with tin, a softer material than copper. The tin is capable to keep the copper oxidation away and to retrain the generation of verdigris. However, due to careless external affection, it creates strain. As shown in FIG. 2, the tin tassel 5′ grows on two cables bridging a short circuit. This is a great latent hazard.

### SUMMARY OF THE INVENTION

Based on the operational requirement and aiming at improve the shortcoming of the prior art of the flexible flat cable, the inventor has worked hard to come up a new flexible flat cable to broad application in industry.

The main object of this invention is to furnish a novel flexible flat cable containing multiple cables to be processed with elongating to gain ductility, pressed to make it a flat form and encased with insulation on the top and bottom surfaces. The exposed section of cable leads on both sides are coated with at least a layer of metal material and stiffened with reinforcement. The utmost coating is gold coating which improves conductivity, to increases the transmission efficiency in LVDS, eliminates the generation tin tassel which grows often in the tin coated surface, prevent the short circuit and ensure the stability.

### BRIEF DESCRIPTION OF THE DRAWINGS

FIG. 1 shows the prior art of flexible flat cable

FIG. 2 is an enlargement of prior art of flexible flat cable.

FIG. 3 shows the first embodiment of the flexible flat cable of this invention.

FIG. 4 shows the second embodiment of the flexible flat cable of this invention.

FIG. 5 shows the third embodiment of the flexible flat cable of this invention.

FIG. 6 shows the fourth embodiment of the flexible flat cable of this invention.

FIG. 7 shows the fifth embodiment of the flexible flat cable of this invention.

FIG. 8 shows the sixth embodiment of the flexible flat cable of this invention.

FIG. 9 shows the seventh embodiment of the flexible flat cable of this invention.

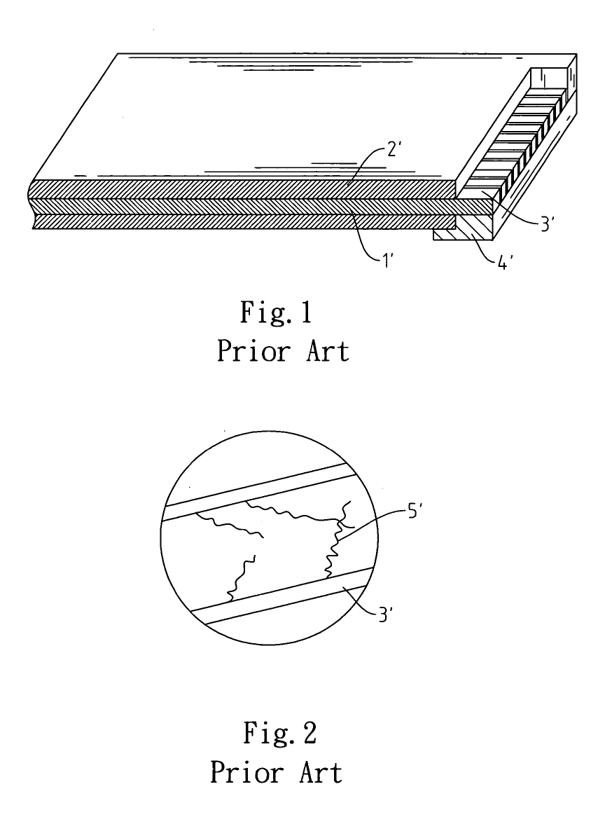

### DETAILED DESCRIPTION OF THE INVENTION

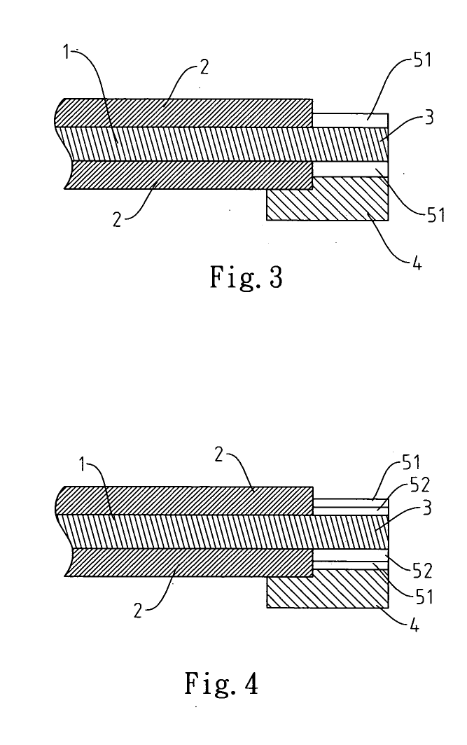

FIG. 3 shows the flexible flat cable 1 of this invention where the multiple round cables are processed by elongating and pressing to make it a flat cable, encase with insulation 2 on the top and bottom surface with the exposed cable leads 3 both sides coated at least one layer of metal material. Cable lead 3 is further stiffened with reinforcement 4. The cable leads 3 of such a flexible flat cable 1 shall be coated with at least a layer of metal to prevent the tin coating from growing tin tassel which would create a short circuit when the tin tassels make a contact bridge.

FIG. 3 shows the first embodiment of the flexible flat cable of this invention, where the conductive cable 1 is a bare copper wire or a tin coated copper wire, after processing with elongating and pressing, the wires become flat form. The exposed cable leads 3 at both sides are coated with a layer of gold 51. The bare copper wire or the tin coated copper wire is not expensive material, however, the exposed cable leads 3 after being gilt, and the conductive efficiency is intensified greatly. For cost effective consideration, the flexible flat cable of this invention will no doubt promote the data transmission rate, in LVDS.

FIG. 4 shows the second embodiment of the flexible flat cable of this invention, where the conductive cable 1 goes the process of elongating and pressing to become a flat cable and encased with insulation as does above. However the exposed cable leads 3 are coated with two layers of metal, the first coating is nickel 52 and the second coating is gold 51. In addition the advantages the flexible flat cable embraces as stated in the previous paragraph, the gilt coating 36 over the nickel coating 52 will enhance the hard adhesion.

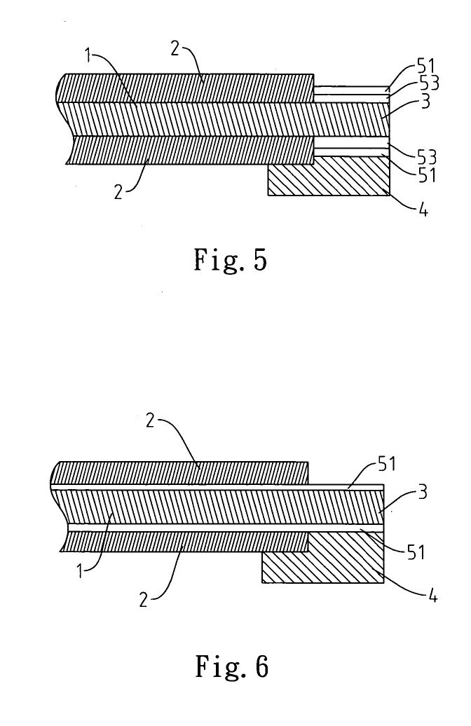

FIG. 5 show the third embodiment of the flexible flat cable of this invention, where the conductive cable 1 goes the process of elongating and pressing to become a flat cable and encased with insulation as does above. The exposed leads 3 are with the first layer of tin coating 53 and the second layer of gold coating 51. In this structure, there is a hard layer formed between the tin coating 53 and the gold coating 51 with no tassel generation as long as the tin coating 53 is wrapped by the gold coating 51.

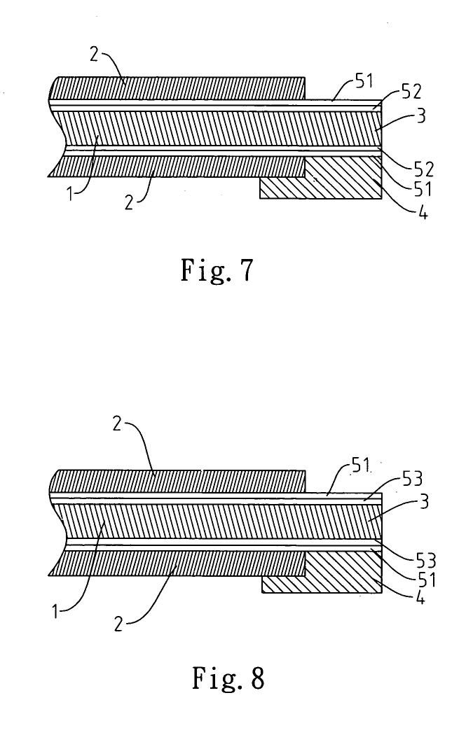

FIG. 6 shows the fourth embodiment of the flexible flat cable of this invention where the conductive cable 1 is a bare copper wire directly coated with gold 51 first. It goes further process of elongating and pressing to become flat cable. The exposed leads are coating coated without additional other coating. FIG. 7 shows the fifth embodiment of the flexible flat cable of this invention, where the conductive cable 1 is a bare copper wire, coated first with a nickel coating 52, secondly a gold coating 51. After elongating and pressing processes, the exposed leads 3 are coated with two metals with no further coating process. Or as shown in FIG. 8, the sixth embodiment, where the conductive cable 1 is a tin coated copper wire coated with a gold coating 51. After processed with elongating and pressing, the exposed leads 3 are coated with a layer of tin coating 53 and a gold coating 51. Conclusively, the exposed leads 3 of the conductive cable 1 have at least one layer of metal coating and the utmost layer is usually of the gold coating 51 to promote the conductivity rate and to elevate the data transmission efficiency in the LVDS. When the tin coating 53 is over coated with the gold coating 51, the tin tassel will never grow, there will never occurs short circuit, and the flexible flat cable is working more stably.

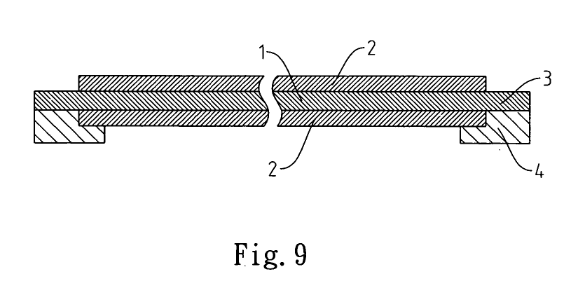

The flexible flat cable of this invention provides the best conductivity, promotes the outstanding data transmission efficiency in LVDS. FIG. 9 shows the seventh embodiment of the flexible flat cable of this invention where the conductive cable 1 of the bare copper wire or a tin coated copper wire is replaced by the pure gold wire, after processing with elongating and pressing, the pure gold wire become flat form. The exposed cable leads 3 at both sides are no need to coated with a layer of gold, and placed directly with reinforcement 4 from one end of the section of conductor 12 to become a reliable flexible flat cable.

Besides, the principle applied in this invention is not only applicable to the two side exposed leads 3 of the conductive cable 1, it also applied to one side exposed lead 3 coated with nickel coating 52 or the tin coating 53 plus a gold coating 51, but the other side exposed lead 3 are coated a single layer of gold coating 51.

The drawing are exposing the embodiment of this invention, however, any one who is familiar with this technology is welcome to make modification or changes as much as he prefers as long as these modifications are not departing from the principles as described in the claims.

1. A flexible flat cable in which the conductive cable is encased with insulation on the top and bottom surfaces and the exposed leads on both sides are coated with at least a layer of metal coating.

2. The flexible flat cable as claimed in claim 1 in which the conductive cable is a bare cooper wire.

3. The flexible flat cable as claimed in claim 1 in which the single metal layer shall be a gold coating.

4. The flexible flat cable as claimed in claim 1 in which two metal layers will contain a nickel coating and a gold coating.

5. The flexible flat cable as claimed in claim 1 in which two metal layers will contain a tin coating and a gold coating.

6. The flexible flat cable as claimed in claim 1 in which the conductive cable can be tin coated copper wire.

7. The flexible flat cable as claimed in claim 1 in which the single metal layer shall be a gold coating.

8. The flexible flat cable as claimed in claim 1 in which the exposed leads can be stiffened with reinforcement.
